(19) United States
(12) Patent Application Publication
(10) Pub. No.: US 2003/0199293 A1
(43) Pub. Date: Oct. 23, 2003

(54) Three dimensional interactive game and method for initiating and playing same

(76) Inventors: Igor Skripachev, Chicago, IL (US); Dmitri Rebrov, Golden Valley, MN (US)

Correspondence Address: JoAnne M. Denison, Suite 1608, 212 W. Washington Blvd., Chicago, IL, 60606-3487, US

(21) Appl. No.: 10/128,081

(22) Filed: Apr. 23, 2002

(51) Int. Cl. G06F 17/00

(52) U.S. Cl. 463/9

(57) ABSTRACT

The present invention consists of an improved three dimensional interactive computer game wherein the user may select either a regular or irregular three dimensional shape such as a cube, sphere, cylinder, pyramid or any other shape, and then select a plurality of discrete elements to fill the shape, whether regular or irregular, and then the user may select the number of discrete elements to fill the three dimensional game playing shape, and then a number of tokens or exploding mines are chosen and then randomly distributed throughout the three dimensional playing shape. The player can then initiate game play and choose a selected game form or cell shape to see if a mine or exploding token is contained therein which will automatically terminate the game play. If the player selects an element which does not contain an exploding mine or token, the selected cell or element is removed and all adjacent elements are shown with an integer value which corresponds directly to the number of adjacent elements or cells located in a specific pattern which contain exploding tokens or mines. The player at any time may flag elements which are suspected to contain mines or exploding tokens. The game ends when either a timer runs out, or all cells or discrete elements are marked as having exploding mines or tokens or have been removed from the playing field. The three dimensional shape may be rotated in any direction during game play and it can be split or blow apart along any axis selected by the user to facilitate game play.

### FIELD OF THE INVENTION

The present invention relates to the field of computer software, and in particular computer software for a game of strategy in which a user selects from a number of adjacent, discrete elements which may or may not contain a token or other indicator which will end the game if it is chosen improperly.

### BACKGROUND OF THE INVENTION

Currently, in the marketplace, there are available a wide variety of computer games which perform a number of different logical and strategic objectives. For example, in the traditional Microsoft version of Minesweeper, a two dimensional game field is initiated by the user and the user selects from a playing field of square discrete elements. If a correct element is chosen, one or more squares are displayed each indicating the number of adjacent elements that have an exploding token contained therein. Squares are revealed automatically whenever the user chooses a square correctly that has adjoining elements or squares with a zero value (or no nearby squares contain any mines), and then all the adjoining zero value elements are displayed together. In such a manner, the user may select the squares which are “safe” or “safer” or which do not contain mines or exploding elements by logically deducing such squares from the value given in surrounding displayed elements. Players are also able to “flag” or mark square that they have determined contain exploding tokens.

In reviewing the prior art, there are numerous patents that concern exploding cells or tokens, but none appear to be a true three dimensional game; rather, they involve adapting a two dimensional game onto the surface of a three dimensional object such as a cylinder or cube.

For example, U.S. Pat. No. 6,332,838 issued to Yamagami discloses the use of a three dimensional display game in the shape of a cylinder or circular playing surface. But the game is only played on the three dimensional surface; it is not played in the interior of a three dimensional object. Similarly, U.S. Pat. No. 5,312,113 issued to TaHsein discloses a three dimensional cube game which is only played on the surface of a cube game. In this particular disclosure, the surfaces of the cube which are not viewable by the user because they are on the backside of the cube are displayed directly adjacent the sides of the three dimensional cube, or on the top, bottom and side of the. Another type of a very simple three dimensional game is disclosed in U.S. Pat. No. 6,062,978 issued to Martino wherein a large plurality of surface elements are positioned onto the surface of a rotating cube which contains crossword puzzle games such as Reversi, Othello and Scrabble. This game has no exploding tokens and merely involves the use of letters and word puzzles which game is only played on the surface of a cube.

Another similar patent disclosed in the prior is U.S. Pat. No. 5,992,849 issued to Olti, et al. which involves an electronic puzzle game with a plurality of indicators with two states wherein winning the game is accomplished by “folding” the playing surface along axes in the proper order along imaginary lines. This particular disclosure does not involve exploding tokens and it similarly is only played on the surface of the game form.

Another two dimensional computer game is disclosed in U.S. Pat. No. 5,643,085 issued to Aityan, et al. which discloses the use of a game with planar or curved configurations having a plurality of game objects which are moveable only in groups and the groupings must be selected and moved in the proper order to a final position. The path chosen must be cyclical in nature. This game does not involve exploding tokens and further only is played on the surface of the game form.

Yet an additional patent shown in the prior art is U.S. Pat. No. 5,423,556 issued to Latypov which discloses the use of an interactive digital computer game with an array of elements in rows and columns. Each element has a feature, such as a color, whereby a player can move elements in groups to form a predetermined pattern and then the proper pattern is removed from the game until the entire game surface is empty. However, this game is only two dimensional in formation.

Still an additional computer game disclosed by the prior art was U.S. Pat. No. 5,215,311 issued to Schuller wherein an electronic amusement device is shown having tokens and multi-colored lights. The colors of the lights determine whether a token is trapped or released for further play. The game ends when a predetermined color pattern appears on the game board and all tokens are trapped. Still, this game is only a two dimensional and not a three dimensional game.

Thus, no where in the prior art is shown a three dimensional game in a variety of three dimensional forms which utilizes tokens which must be avoided in order to successfully remove all discrete elements from both the exterior and the interior of a three dimensional object in order to win the game.

### SUMMARY OF THE INVENTION

The present invention consists of a truly three dimensional game in which discrete elements are displayed adjacent one another to create a three dimensional form. Tokens are then randomly distributed within the form. The user then selects a beginning element and if the element contains a token, the element “explodes” and the game is over. If the element does not contain a token, then a value is displayed on each of the six sides of the element (although some values may not actually be seen because they are obscured from view depending on the view chosen by the user), and the user can then select the best or safest element to continue with the game until all elements are either flagged with containing an exploding token and all safe elements are chosen and removed from the playing surface. The game may be either timed or not timed during play. The three dimensional object created may be a cube, a cylinder, a cone, or the user can even build his or her own desired object in a separate subroutine. The elements themselves may be cubes, spheres or any other shape chosen by the user at the time the game is set up or begun.

During play, it is anticipated that the user can use either a mouse or cursor keys to rotate the object within a three dimensional space, with the values of the elements rotating therewith. The object may be rotated along any plane or axis. Further, the object can be split apart along any plane chosen by the user according to longitude, latitude or depth of the object. The values will continue to be shown alongside each element remaining on the playing field, the chosen view permitting.

In such a manner, an extremely aesthetically pleasing and amusing game is created with outstanding visual effects which is a vast improvement over the two dimensional games and two dimensional games played on a three dimensional surface currently seen in the marketplace. Thus an unique and completely flexible logical puzzle game is created which is most interesting for the player to solve in variety of fashions.

### OBJECTS OF THE INVENTION

Thus, it is one primary object of the present invention to provide a three dimensional computer game having discrete elements adjacent one another which create a form which the user can select from a wide variety of arrangements, such as a cube, pyramid, sphere, cylinder, cone, teardrop, etc.

It is yet an additional primary object of the present invention to provide a three dimensional computer game having discrete elements adjacent one another which create a form wherein the form can be custom created by the user during the set up of the game.

It is still a further primary object of the present invention to provide a three dimensional computer game having discrete elements adjacent one another wherein the user can select the three dimensional shape of the discrete elements, whether they be individual cubes, squares, pyramids, cones, teardrops, etc.

Still another primary object of the present invention is to provide a three dimensional computer game having discrete elements adjacent one another which create a form wherein the elements were randomly selected to contain an “exploding” token such that the discrete elements “explode” or end the game if they contain an exploding token and these tokens may be hidden in elements either on the surface of the object, or they may be embedded at any location within the interior of the form.

A further primary object of the present invention is to provide a three dimensional computer game having discrete elements adjacent one another which create a form wherein after one or more elements has been safely selected by the player, then the value of number of adjacent elements containing tokens is displayed on all viewable sides of the elements which have been safely chosen.

Still an additional primary object of the present invention is to provide a three dimensional computer game having discrete elements adjacent one another which create a form wherein the form may be rotated by the user to any view, whether horizontally, vertically or along any axis by using either a mouse or by using cursor keys, so that all remaining elements and their associated token values may be readily seen by the player for the most efficient and interesting play of the game.

A further primary object of the present invention is to provide a three dimensional computer game having discrete elements adjacent one another which create a form wherein the user can select the size of the form in its horizontal and vertical directions, as well as depth.

An additional primary object of the present invention is to provide a three dimensional computer game having discrete elements adjacent one another which create a form wherein the user can select the number of tokens desired to be randomly placed in the discrete elements of the game to make the game harder or simpler as desired.

Yet an additional primary object of the present invention is to provide a three dimensional computer game having discrete elements adjacent one another which create a form wherein the interior of the object may be displayed by the player along any axis to see any hidden values of remaining elements so that the player may engage in the most efficient and interesting play of the game and select from among the safest remaining elements in the game.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 is a perspective view of a cube version of the game showing a cube rotating in space with some of its discrete elements taken away and values of adjacent elements appearing in the playing field.

FIG. 2 is a perspective view of a cylinder version of the game showing a cylinder version of the game with corresponding elements split along a vertical axis of the game and some elements having been successfully removed by the player.

FIG. 3 is a flow chart of typical initiation of a game.

FIG. 4 is a flow chart of typical game flow.

### DETAILED DESCRIPTION OF THE DRAWINGS

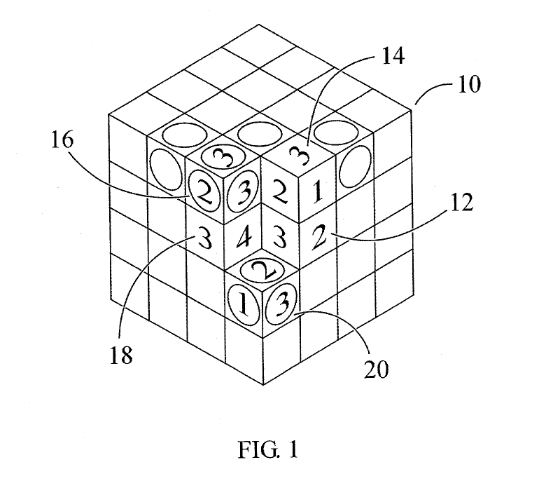

Shown now in FIG. 1 is a configuration of a very typical three dimensional playing cube 10. Two of the corner elements (which are also cubic in configuration) have been removed and integer values have been correspondingly calculated for each of cubes 12, 14, 16, 18 and 20. It should be noted that although circles appear on some, but not all of the cubes in FIG. 1, the circles are shown on this drawing for the purposes of illustrating where hidden tokens may be actually found. They will not appear during play of the actual game, and are only used for purposes of explaining FIG. 1 in this patent application. Accordingly, for purposes of illustration in this application, tokens are likely to be located in cubes which have circles on their sides. This is one of the possible token positions. In fact, the player will not know where the tokens are inasmuch as they are not shown in this Figure. The values of these cubes directly correspond to the number of discrete elements or cubes on adjacent sides having a hidden exploding token contained therein which, when chosen, will immediately end the game. In this particular instance, cube 12 has a value of 2 on one of its faces which means this is the total amount of all tokens contained in the cubes surrounding it in the same plane which contain the number 2, plus its own interior contents. Normally, if a cube or a discrete element is in the center of a form, it will have eight cubes surrounding it which will be counted in its value, as well as itself, if it contains an exploding token. Accordingly, values can range from 0 to 9, but 0 is never displayed in this particular embodiment.

With regard to cube 14, this has a value of 3 on its top face which means that there are 3 tokens in the 4 remaining cubes surrounding it, plus itself. Similarly, cube 16 has a value of 2 on one of its sides which means there are 3 remaining cubes surrounding it plus itself, which may contain an exploding cube. Similarly, with regard to cube 18, this cube has a value of 3 on its front left side face and this would mean that there are 3 exploding tokens which could either be within itself or within the six remaining cubes that surround it in same plane. It is the same for cube 20 which has a value of 2 and has three cubes surrounding it in the same plane plus itself; however, the three surrounding cubes are hidden beneath other cubes.

Prior to initializing this three dimensional playing cube, the player was able to specify in the set up of the game that a cube or box form was desired and that the cube or box was to be 4 elements high by 4 elements wide by 4 elements deep, or 64 elements total, and of these elements, 12 tokens were selected by the user to be randomly hidden within the 64 elements of the cube or box form.

Of course, in order to see all sides of the cube, the user was able to use the mouse to rotate the cube up or down, to the left or right, or a combination of these by moving the mouse in the appropriate direction. By clicking on the left button, the form rotates in one direction whereas by clicking on the right button, the form rotates in the opposite direction. When two directions are chosen, for example, up and to the right, the cube will follow such an intermediate path of rotation chosen by the user. Similarly, where no mouse is present, the cursors may be used and the cube automatically rotates in one direction and by using a second key, such as cntrl or alt together with the cursor keys, the cube will automatically rotate in an opposite direction. Two cursor keys may be pressed when it is desired to rotate the cube in a direction 45 degrees from either path.

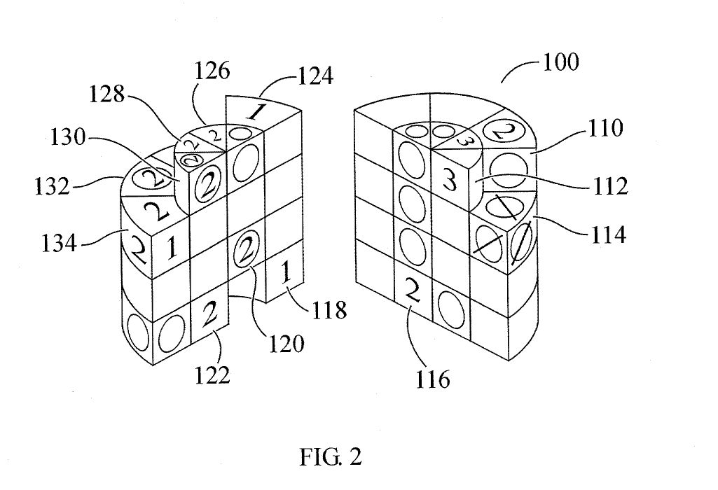

FIG. 2 shows a cylindrical version of the present invention, three dimensional playing cylinder 100, with both outer circular segment discrete elements, as exemplified by circular segment elements 110, 114, 118, 124, 132 and 134 about its outer periphery, and wedge shaped elements 112, 120, 122, 126, 128 and 130 within the core of the form of three dimensional playing cylinder 100. It should be noted that the game becomes more interesting because while the outer circular segment elements, 100, 114, 118, etc. all have six sides like a cube, the wedge shaped elements 112, 120, etc. only have five sides. Four circular segment elements have been removed successfully along the top of three dimensional playing cylinder 100 and one wedge shaped element has been removed successfully at its bottom. As in the prior embodiment, circular segment 124 has a value of 1, meaning that an exploding token will be found either in the interior circular segment, or in wedge 126 or within itself. As another example, wedge shaped element 126 has a value of 2 meaning that there are 2 exploding tokens in the upper layer of the wedged shaped cells, plus nearby circular segment 124. Circular segment 114 is interesting because it has a circle with a slash through it, indicating that the user has marked is as containing a mine. Obviously when the circular segment above it was removed, this element had a value which would indicate that a token in that location had to have a an exploding token above it. The user then right button clicks on the cell with the exploding token and marks it so that he or she does not forget later that the cell has an exploding token and accidently clicks on it again.

This particular FIG. 2 is also interesting in that it shows the three dimensional playing cylinder 100 cut apart or blown apart along one of its vertical axes. In such a situation, the user will select from a “view” pull down menu, and then select whether the plane to view is horizontal or vertical and then the user next clicks on the point which the view will be taken through. Of course, the user can also be given the choice of selecting a rotating axis so that an alternative view along an incline of say 10 degrees, 45 degrees, etc. may be taken either by inputting the number directly or by clicking once for the center point of the plane and clicking again to rotate the axis. Other methods may be used to accomplish the same task. In this instance, the user has selected a central vertical plane by clicking on a point between two circular segment elements on the outer surface of the cylinder to see number valuations in the center of three dimensional playing cylinder 100 which makes it much easier to play the game from the interior of the form.

When specifying the size of the regular form, three dimensional playing cylinder 100, the user was asked to specify how many outer rings (in this case only one), and how many layers (in this case four), and the image was automatically generated by the game software. Of course, additional outer rings which create more segments can be requested by the user and how many elements in length can also be altered. The third dimension of how many segments or slices per layer may also be defined by the user, if desired. In such a manner, the game becomes much more interesting and challenging as the user must keep track of all surrounding cells or elements in a particular layer, as well as the cells or elements above and below each element to be considered to be selected or not selected and marked as dangerous or containing an exploding token.

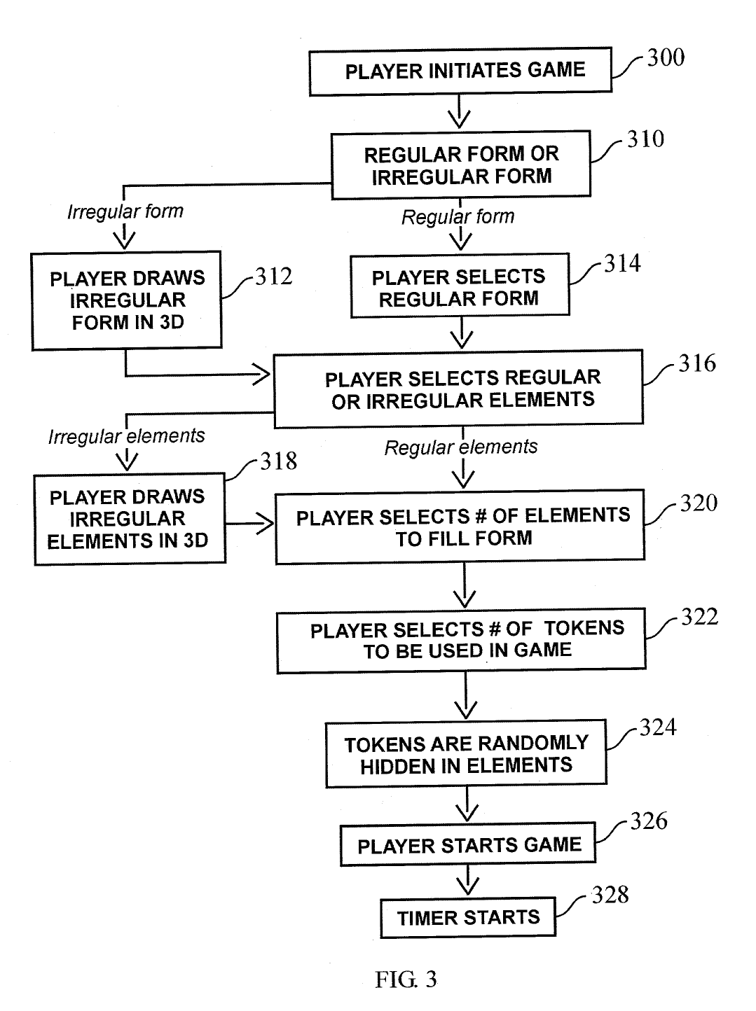

FIG. 3 shows a flow chart of a typical game initiation set up sequence 300 or set up for any particular game. In this particular game playing method, the user first selects whether a regular form or an irregular form will be used to play the game 310. If an irregular form is selected, then the player enters into a standard CAD subroutine where the player can draw and generate an overall three dimensional shape for the form of the game 312. If the player does not select an irregular form, but wishes to choose a standard game form shape such as cube, cylinder, pyramid, sphere, etc., then the player merely selects from one of the standard menu choices 314. Next, the player will be asked whether the discrete elements or cells used to play the game will be regular or irregular 316. If the player selects an irregular shape, the player will be directed to a subroutine where the player can utilized standard CAD software to design the shape desired for the individual elements or cells to be utilized in playing the game 318. Of course, if the player selects narrow or hour glass shaped cells, the player may be able to see more values on surrounding elements, but then the view may become more complex to play the game. In any case, the player will then be asked to select the total number of elements to fill the interior of the shape 320. Of course, some restraints will be placed on this according to the shape chosen. For example, a box or cube will have columns in the horizontal direction, rows in the vertical direction and depth of columns. A cylinder will have number of rings about a central core and number of columns. A sphere will have number of radial segments and number of rings from a central core. A pyramid will have number of squares in the base and number of rows in the vertical axis. For irregular shapes, there will be number of columns across the vertical axis and number of rings therefrom.

The user then chooses how many tokens to randomly hide within each of the elements or cells 322. This is certainly also provided with a range of choices from about 5% for the easiest level of game to about 25% for the more playing levels of games. The tokens are then randomly hidden in the elements or cells 324 by the software and the player will then be able to commence play fo the game 326. If a timer is desired for scoring, then the timer will begin timing how long it takes for the player to win the game 328.

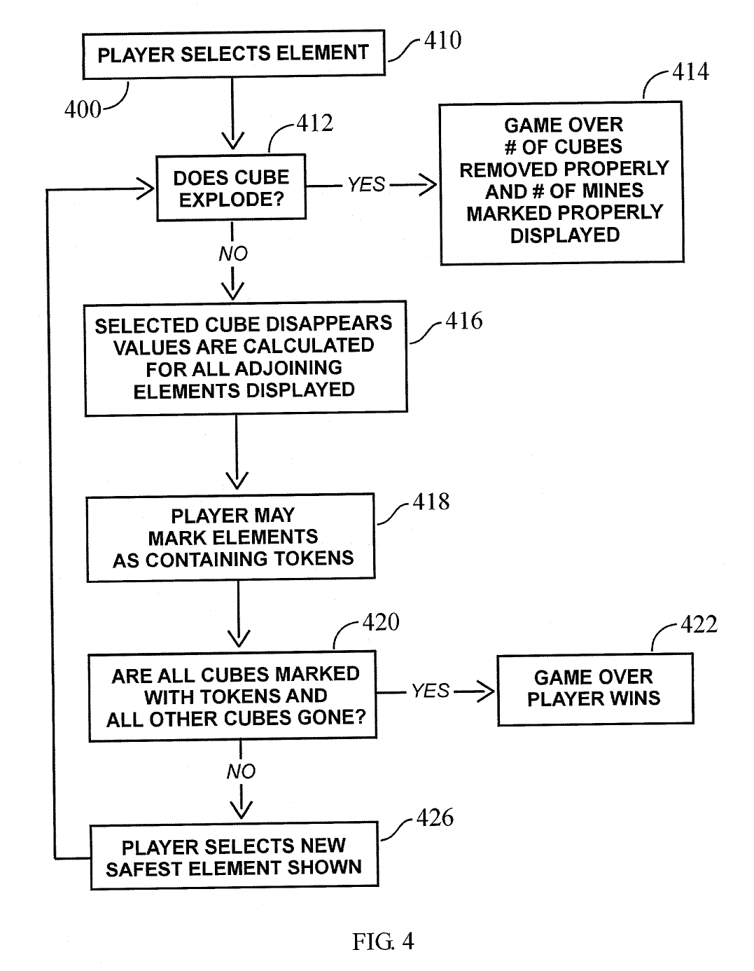

FIG. 4 shows a flow chart for typical play of the game. In game play method 400 is shown how the player will randomly select an element 410 to see if it is safe or if it will explode 412. If the cube explodes then the game is over and the number of cells removed properly and the number of mines marked properly is displayed, together with the number of marking errors 414. With such statistics, players can play against one another to determine who is the champion. If the cube did not explode, the selected cube or element will disappear from the playing field and an integer value will be displayed on at least one surface of all adjacent elements of cells 416. This integer value will represent the total number of tokens or exploding mines which are present in all adjacent cells. At this juncture, the player may determine that a particular cell or element must certainly contain a mine or token and the player may mark or cross off that cell by right clicking with the mouse or pressing a computer key such as alt or cntrl after cursoring to it so that the player will not inadvertently choose the cell later. Of course, if the cell is wrongly marked as having a token or mine within it when it does not, it will count against the player in the player's total score at the end.

After the player has marked any desired cells, the player can review whether there are any additional cells or elements to choose from, and if there are not, the player can end the game and see if they were correct in their selections regarding tokens/mines 420. If they were wrong, then incorrect cells are counted against them. If there are still more cells or elements to select or choose from, then the player starts the process again and selects a new cube or element 426 until all cells or elements are selected or marked and the game ends.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

What is claimed is:

1. A three dimensional interactive computer game comprising a CPU, a display for a CPU, a three dimensional form or shape boundary displayed on a playing field, a plurality of discrete three dimensional elements in the interior of the three dimensional form or shape boundary wherein the elements extend along a vertical axis, a horizontal axis and a depth axis, a plurality of tokens which are randomly placed within some, but not all of the three dimensional elements which, when chosen or selected by a game player or user, will end the game.

2. The computer game according to claim 1 wherein the three dimensional form is one selected from the following group: cube, cone, sphere, pyramid or cylinder.

3. The computer game according to claim 1 wherein the shape of each discrete element or cell is one selected from the following group: cube, cone, sphere, pyramid or cylinder.

4. The computer game according to claim 1 wherein the three dimensional form may be rotated around its axis by moving and clicking with a computer mouse or key.

5. The computer game according to claim 1 wherein some or all of the elements have at least one indicator appear thereupon.

6. The computer game according to claim 1 wherein when one element is selected by the user, it is removed or disappears from the playing field and all adjacent elements will automatically indicated an integer value corresponding to the number of its adjacent cells which contain tokens which will end the game if selected.

7. The computer game according to claim 1 wherein tokens may move from one element or cell into another element or cell at anytime during game play.

8. The computer game according to claim 1 wherein the three dimensional form may be shown in a blown apart view along a plane which is selected by the user with a computer mouse or key.

9. A method of playing an interactive game comprising the steps of:
providing a CPU or central processing unit for a game player and a game program;
the player initiating the game program and the game program providing a three dimensional playing field;
the game program generating a three dimensional shape or game playing form and generating a plurality of adjoining discrete elements or cells each having a three dimensional shape and placing the elements or cells within the boundary of the three dimensional shape and generating a plurality of tokens and then randomly distributing these tokens throughout the discrete elements or cells and then initiating play of the interactive the game;
the player then selecting a cell or discrete element to determine whether it contains a token;
the game program determining whether the discrete element or cell contains a token to end the game;
if the player did not select a discrete element or cell with a token, then the discrete element cell disappearing from the playing field;
the player then selecting another discrete element or cell if the game has not ended and the play continuing until all discrete elements or cells are removed from the playing field.

10. The method of playing an interactive game according to claim 9 after the game program has determined that the player has not selected a cell containing a token, indicators values are displayed on cells adjacent the selected cell, then determining which adjacent cells contain a token and providing an indicator on each of the adjacent cells to the chosen cell and providing the player with an opportunity to mark one or more cells as containing tokens to avoid inadvertently choosing them later in the game.

11. The method of playing an interactive game according to claim 9 wherein before game play is initiated, the player entering into a game setup subroutine and the player selecting from a plurality of different three dimensional shapes one shape to determine the game playing form.

12. The method of playing an interactive game according to claim 9 wherein before game play is initiated, the player entering into a game setup subroutine and the player selecting from a plurality of different three dimensional shapes one shape to be used for the shape of the discrete elements or cells during game play.

13. The method of playing an interactive game according to claim 9 wherein before game play is initiated, the player selecting the number of tokens to be randomly distributed throughout the discrete elements or cells during game play.

14. The method of playing an interactive game according to claim 9 wherein during play of the game adding the step of the player using a cursor, mouse or computer key for selecting a horizontal or vertical plane through which the playing shape or form may be split in order to view the interior of the playing shape or form to enhance game play.

15. The method of playing an interactive game according to claim 9 wherein during play of the game adding the step of the player using a cursor, mouse or computer key for selecting a direction through which the playing form may revolve and then revolving the playing form accordingly until the desired view is achieved in on the three dimensional playing field.

16. The method of playing an interactive game according to claim 9 wherein before game play is initiated, adding the step of the player selecting the number of discrete elements or cells to fill the three dimensional game playing form.

17. The method of playing an interactive game according to claim 9 wherein any or all of the tokens may move from one discrete element or cell into another element or cell at anytime during game play.
